(19) United States
(12) Patent Application Publication
(10) Pub. No.: US 2026/0242185 A1
(43) Pub. Date: Aug. 20, 2026

(54) METHOD, SYSTEM AND COMPUTER PROGRAM PRODUCT FOR MOVING A LOAD BY MEANS OF A PLURALITY OF CRANES

(71) Applicant: LIEBHERR-WERK NENZING GMBH, Nenzing (AT)

(72) Inventor: Walter MIETSCHNIG, Brand (AT)

(21) Appl. No.: 19/160,715

(22) PCT Filed: Feb. 5, 2024
(86) PCT No.: PCT/EP2024/052725

§ 371 Date: Aug. 28, 2025

(30) Foreign Application Priority Data
Apr. 18, 2023 (DE) 10 2023 109 701.6

(51) Int. Cl. B66C 13/48; B66C 13/06

(52) U.S. Cl. CPC B66C 13/48; B66C 13/063

(57) ABSTRACT

The invention relates to a method for moving a load using a plurality of cranes with a luffing jib. According to the invention, one of the cranes is designed as a leading crane, the movements of which are followed by the other trailing cranes, and the control units of the cranes exchange data. Upon lifting/lowering the load, the lifting mechanisms of the trailing cranes are regulated such that the height of the load contact points on the respective load receiving means (lifting height) remains within a defined window around the lifting height of the leading crane. The luffing and lifting mechanism of the crane is automatically controlled and/or regulated for a lateral load movement such that during a luffing movement of the jib, the lifting height remains constant. If a deviation of the lifting cable from the vertical is detected, the luffing mechanism and/or rotating mechanism is controlled and/or regulated.

### CROSS REFERENCE TO RELATED APPLICATIONS

The present application is a U.S. National Phase of International Application No. PCT/EP2024/052725 entitled “METHOD, SYSTEM, AND COMPUTER PROGRAM FOR MOVING A LOAD BY MEANS OF A PLURALITY OF CRANES”, and filed on Feb. 5, 2024. International Application No. PCT/EP2024/052725 claims priority to German Patent Application No. 10 2023 109 701.6 filed on Apr. 18, 2023. The entire contents of each of the above-listed applications are hereby incorporated by reference for all purposes.

### TECHNICAL FIELD

The present invention relates to a method for moving a load by means of a plurality of cranes, to a corresponding system, and to a computer program product as described herein.

### BACKGROUND AND SUMMARY

Conventional tandem or multi-crane lifting requires constant communication between the crane drivers of the cranes involved in the lifting, and a defined signaler or supervisor, in order to be able to perform the synchronized crane movements for the joint lifting of the load. A particular feature in the case of such multi-crane lifting is that the movements of the other cranes are relevant for the safety of each crane. Thus, for example in the case of diagonal pull (i.e. the lifting cable deviates from the vertical) overloading of one or more of the participating cranes may occur, or in the case of non-synchronous lifting/lowering a displacement of the center of gravity of the raised load may occur, and thus also overloading of one or more of the participating cranes. Likewise, collisions of the cranes with one another and with obstacles, as well as maneuvering in “forbidden” positions, out of which the crane can no longer move independently, must be prevented.

For this reason, such multi-crane lifting is a complex and safety-critical undertaking, and requires knowledge of a range of information that must be known or calculated, for example the center of gravity of the load to be lifted, the masses of the load and the load receiving means, and the proportional cable weight, its distribution over the individual cranes, the current diagonal pull, the utilization of the maximum payloads of the cranes, etc.

In such multi-crane lifting, dangers result in particular from the overloading of cranes on account of diagonal pull and as a result of a displacement of the center of gravity due to non-synchronous lifting/lowering of the load.

In particular in situations in which cranes are used, for multi-crane lifting, which are not equipped identically, difficulties also occur in the synchronization of the individual crane movements. If, for example, cranes with a luffing jib (e.g. lattice mast cranes with a main jib or with a luffing tip, rotating tower cranes with a luffing jib, etc.) are used, which differ in their setup condition (e.g. jibs of different lengths or pivotable about different axes), then these cranes perform a different jib head movement during luffing of their jibs about the same angle. Thus, with the same lifting cable length, the contact points of the load on the respective cranes move on different paths or at different locations. In order to compensate for this effect, at least one of the cranes would also have to retract or let down the lifting cable, in addition to the luffing movement, in order to compensate for the height difference of the contact point.

If a rotation of the crane is required for moving the jointly lifted load, then one of the cranes must, in addition to the rotational movement, also luff the jib and simultaneously adjust the lifting cable, while the other crane only performs a rotational movement, in order that the load is moved at the same height. The individual movements are so complex that diagonal pull is virtually unavoidable.

In the case of high or low centers of gravity, non-synchronous lifting/lowering of the load also results in displacements of the center of gravity, and thus to a load change or even overload risk of one or more cranes. In this case, a crane involved in the lifting may be overloaded, without itself performing a lifting mechanism movement, if e.g. in the case of a low center of gravity position the other crane lowers the load and thus the center of gravity shifts towards the stationary crane. As a result, the load on the stationary crane increases and this could become overloaded. Therefore, synchronous lifting/lowering of the load is an essential requirement for safe multi-crane lifting.

If it is not possible to exactly acquire and correct all the relevant factors, then according to the applicable regulations the payload utilization should be appropriately downgraded or reduced for all the cranes involved. The reduction can be 25% or more. The nominally permissible utilization of the payload can thus be 75% or less. If, in contrast, all the mentioned influencing and risk factors can be precisely determined and monitored by instruments, then the cranes involved can be operated up to their nominal payload.

Against this background, the object of the present invention is that of being able to perform the lifting or moving of a common load, by means of a plurality of cranes, more safely and more effectively.

According to the invention, this object is achieved by a method having, by a system, and by a computer program product as described herein.

According thereto, a method for moving a load by means of a plurality of cranes is proposed. The cranes used for the method each comprise an upper structure that is rotatable by means of a slewing gear about a vertical axis of rotation, a jib that can be luffed about a horizontal axis by means of a luffing mechanism, a load receiving means that is vertically adjustable by means of a lifting mechanism and is intended for receiving a load, and a control unit by means of which the upper structure, the jib and the load receiving means (or the corresponding drives or actuators) are automatically controllable. The jib can for example be a jib mounted on the upper structure, in particular a lattice mast jib, a luffing tip fastened to a main jib, or a luffing jib of a rotating tower crane. The lifting mechanisms of the cranes preferably each comprise at least one lifting winch, on which in each case at least one lifting cable, guided over a jib tip, is mounted such that it can be wound up and unwound, and on which the load receiving means is fastened.

In the case of such cranes, the problem described at the outset exists, whereby luffing of the jib leads not only to a lateral movement but rather also to a vertical movement of the load. Precisely when different cranes are used (e.g. different crane types or simply differently equipped), a synchronous movement for achieving a specified movement of the jointly lifted load is therefore particularly challenging.

According to the invention, it is provided that one of the cranes involved in the joint lifting is defined as a leading crane. The other cranes are trailing cranes which follow the movements of the leading crane, in particular automatically. This is preferably achieved by corresponding automatic control and/or regulation of the actuators of the trailing cranes (in particular the slewing gear, luffing mechanism and lifting mechanism), involved in the movements, by the control units of the trailing cranes. In order to allow for this procedure, the control units of the cranes involved in the lifting exchange data. For example, the control units of the trailing cranes (or the crane drivers) must know what movements the leading crane is currently performing (or know the current position of the leading crane at successive timepoints), in order to be able to correspondingly control and/or regulate the trailing crane's own movements.

According to the invention, the lifting mechanisms of the trailing cranes are regulated upon lifting or lowering of the load such that the heights of the contact points of the load on the respective load receiving means (referred to in the following as lifting height) of the trailing cranes remain within defined ranges or windows around the lifting height of the leading crane. In this case, a window is understood to be a height portion between a lower and an upper limit.

The regulation for repositioning the lifting heights can take place by the operator or crane driver. For this purpose, said operator or driver is provided with the information required for this (e.g. the current own lifting height, the current lifting height of the leading crane, the defined window, a limit of the window and/or a parameter representing the current deviation from the leading crane lifting height-optionally with respect to a limit). This information can be displayable on a crane display and/or on a mobile display device associated with the trailing crane. In this case, the crane driver is assisted with the manual repositioning of the lifting height, such that the lifting heights of the trailing cranes can remain within specified windows around the lifting height of the leading crane.

Alternatively, the regulation of the lifting height repositioning can be performable automatically by the control units of the trailing cranes. For this purpose, the control units of the respective trailing cranes regulate the lifting mechanisms in such a way that the contact points remain within the window defined by the upper and lower limits.

The upper and lower limits of the defined windows are in particular defined as spacings from the current lifting height of the crane, and may be identical or different. For regulating the lifting height, any desired reference points can be consulted, for example the contact points of the load itself, any point of the load receiving means, or a defined point on the lifting cable.

According to the invention, the luffing and lifting mechanisms of the cranes are automatically controlled and/or regulated for a lateral movement of the load (i.e. the movement vector has a horizontal component), by the respective control units, such that during a luffing movement of the jib the lifting height remains constant. Upon luffing of the jib, the contact point of the load is thus moved at a constant height. This simplifies the load coordination when moving the load using a plurality of cranes, since the load remains at a constant height while the cranes perform different movements of the jibs. It can be possible to initiate keeping the lifting height constant by input of the crane driver or fully automatically by the control unit.

Of course, superimposed movements are also possible, in which the load is both lifted/lowered and moved laterally. In the simplest case, for this purpose superimposition takes place of the above-descried control for achieving a constant horizontal movement and control of the lifting mechanism for changing the lifting height.

According to the invention, furthermore, in the case of at least one crane involved in multi-crane lifting a deviation from the vertical of a lifting cable carrying the load receiving means is measured. In this case, in particular both the deviation to the front/rear (i.e. in parallel with the luffing plane) is measured and analyzed. If a deviation from the vertical is identified, there is diagonal pull of the crane considered, which must be compensated. For this purpose, the luffing mechanism and/or the slewing gear is controlled and/or regulated by the control unit such that the deviation from the vertical is compensated for. The lifting cable is thereby held vertical in the case of this crane, such that when the load is moved, which often constitutes a superimposition of complicated individual movements of the cranes involved, no diagonal pull occurs. The compensation of the deviation from the vertical can be initiable by an input of the crane driver or fully automatically by the control unit.

In the simplest case (multi-crane lifting with just two cranes), the monitoring and correction of the diagonal pull can be carried out in the case of just one single crane involved in the lifting, since the forces when lifting are always in equilibrium, and therefore a diagonal pull in the case of one crane means that at least one second crane also has a diagonal pull. If the diagonal pull is compensated in one crane, this also eliminates the diagonal pull in the other crane. Of course, it is also possible, however, to monitor the diagonal pull in a plurality or even all of the involved cranes. The compensation following an identified diagonal pull can take place sequentially, i.e. firstly the diagonal pull in one particular crane is compensated. If a diagonal pull then still remains, after the compensation, in one or more of the remaining cranes involved, the diagonal pull in a second crane is compensated, etc.

The cranes performing the joint lifting can comprise a chassis and be moved on the construction site. In this case, it may be difficult for all the cranes to travel in exactly the same direction of travel and for the lateral spacings of the jib tips, over which the lifting cables are guided, to remain constant relative to one another. Rather, it may be the case that these drift apart from one another or move towards one another on account of unevenness of the ground or imprecise chassis actuation and rolling resistances. This leads to diagonal pull on the lifting cables of the moving cranes. This diagonal pull, resulting from drift, can be indicated by the control/regulation means according to the invention and be compensated, preferably fully automatically, by corresponding compensation movements in the luffing mechanism and/or slewing gear.

The described control and regulation processes (repositioning of the lifting heights, horizontal movement of the load, compensation of diagonal pull-these can all be implemented as individual assistance systems in the control units, which can be used simultaneously) can all be performable fully automatically by the control units of the cranes, such that ideally this is no longer dependent on human coordination. This reduces the error susceptibility and minimizes the potential risk of overloading or maneuvering in critical ranges. Alternatively, for example, the repositioning of the lifting heights of the trailing cranes can be performable manually (and in an assisted manner) by the crane driver of the trailing cranes, while the diagonal pull correction and the maintenance of the horizontal load path is performed automatically by the control units.

Preferably, a superimposed control of the load movement is possible at any time, for example a superimposed rotation or luffing of a crane by an operator. In this case, the assistance systems used, according to the invention, together, preferably still remain, i.e. in the case of manual luffing of the jib of a crane the lifting cable length is adjusted automatically, such that a horizontal movement of the load still results, and/or the angle of rotation of a crane is adjusted automatically, such that there is still no diagonal pull.

The method according to the invention can be performed with just one single operator, who specifies the movement of the load, for example via an input device in the leading crane or via a mobile input device. The method can also be performed with more than one operator, who specifies the load movement. The control of the leading crane and the repositioning of the trailing cranes is then undertaken automatically by the control units. Alternatively, each crane can be assigned an operator or crane driver, who can manually intervene in the automatic control of the crane.

At this point, it is noted that in the present case the terms “tandem lifting” and “multi-crane lifting” are used synonymously and refer to the lifting or moving of a common load by a plurality of (i.e. at least two) cranes.

The control units can be the crane controller or a part thereof. Alternatively, the control units could be configured as separate computing units which are connected to the crane controllers.

Preferably, the control units of all the trailing cranes are configured to perform an automatic diagonal pull correction. In this case, repositioning of the lateral movements of the leading crane (e.g. in the case of a rotation of the upper structure and/or pivoting of the jib of the leading crane, in order to move the load laterally) can optionally be performable only via the automatic diagonal pull corrections. Since each trailing crane is actuated by the control unit in such a way that the respective lifting cable always remains vertical, this means that the lateral movements of the trailing cranes are adjusted to the movement of the leading crane such that the spacings of the contact points of the load or the jib tips always remain constant (otherwise diagonal pull would result). However, this already achieves repositioning of the lateral movements of the trailing cranes. The repositioning of the lifting heights can take place simultaneously, automatically or manually.

In a possible embodiment it is provided that at least three cranes are used for carrying out the method, which cranes lift or move a common load. Thus, there are at least two trailing cranes which follow the movement of the leading crane. In this case, different windows for the repositioning of the lifting height can be specified for the at least two trailing cranes, i.e. different limits for the maximum deviations of the lifting heights from the current lifting height of the leading crane. This may be expedient in particular if the trailing cranes are of different types or are equipped differently. Alternatively, identical windows for the trailing cranes can also be defined. The windows can be specifiable or adjustable by an operator or a signaler. As a result, it is possible to respond to the current conditions on the construction site.

In a further possible embodiment it is provided that after contact of the load the lifting heights of the trailing cranes are set to a fixed value relative to the lifting height of the leading crane (calibration). For example, the differences of the lifting heights between the trailing cranes and the lifting height of the leading crane can be set to zero, or the ratios of the lifting heights to one. During lifting, the differences or ratios of the lifting heights of the trailing cranes to the lifting height of the leading crane are then continuously monitored and optionally corrected by the control units of the trailing cranes. After contact of the load and before the calibration of the lifting heights, the lifting mechanisms (or the lifting cables) are preferably slightly preloaded. This can be achieved automatically by the control devices of the cranes.

In a further possible embodiment it is provided that the load receiving means of the cranes are suspended on lifting cables which are guided over jib tips of the jibs, wherein the movements of the trailing cranes are automatically matched to the movement of the leading crane in such a way that the lateral spacings of the jib tips with respect to one another remain constant. This counteracts a formation of diagonal pull. Alternatively or in addition, the movements of the trailing cranes can be automatically matched to the movement of the leading crane such that a specified orientation of the lifted load remains constant during a movement of the crane. In this case, the operator merely has to specify the direction in which the load is to be moved. Alternatively it is conceivable to keep the position e.g. of the center point of the load constant, while the operator for example specifies a certain rotation of the load.

In a further possible embodiment, it is provided that a warning is output and/or the movements of all the cranes are stopped if the lifting height of a trailing crane is outside a specified window or if the detected deviation of a lifting cable from the vertical exceeds a specified threshold value. The warning can be in the form of an acoustic signal and/or a corresponding optical display (e.g. on the crane display of the crane in question and/or on a mobile display device). Preferably, in the case of too great a deviation of the lifting height or the lifting cable orientation, the crane movement is stopped, such that the crane in question can be returned to the allowable range by the crane driver, in particular by manual control.

In a further possible embodiment it is provided that the movement (i.e. in particular the target position and/or a route) of the lifted load is specified and/or controlled via an input means. The leading crane is controlled on the basis of the inputs of the input means, i.e. on the basis of the control commands input via the input means. The trailing cranes are caused to follow the leading crane, manually or automatically, by the control units, such that the load performs the specified movement. The input means can be located in a crane, in particular in the leading crane. Alternatively, the input means can be configured as a mobile input unit, such as a tablet. It is also conceivable for a plurality of input means to be provided, i.e. one in the leading crane and one mobile device.

In a further possible embodiment it is provided that each crane comprises a monitoring means for load torque limitation. This can be part of the respective control unit or be executed on its own unit. The cranes comprise corresponding detection devices for detecting the load currently acting on the respective crane. The detected values are transferred to the monitoring means, which compares these with corresponding threshold values for the cranes (these may differ from crane to crane—depending on the crane type and setup condition or current orientation). If, in one of the cranes, the detected current load exceeds the maximally permitted load valid for the current position then the load torque limitation outputs a warning and/or stops the movements of the crane. The crane in question signals its movement stop to the other cranes involved, such that these also perform the stopping process. Thus, when performing the method according to the invention conventional load torque limitation means can be used, which continuously monitor the maximally permitted loads or allowable payloads of the cranes and automatically intervene in the case of this being exceeded (or being imminently exceeded).

Furthermore, a predictive calculation of the loads occurring when the current crane movements are continued can be performed, and thus early intervention is possible. Such a predictive calculation can also be used for preventing the cranes being maneuvered into positions which they can no longer leave without causing damage on one of the cranes.

Furthermore, the cranes can comprise means for monitoring and preventing collisions with one another and with other obstacles (e.g. buildings). For this purpose, corresponding sensors and/or cameras can be installed on the cranes, which detect the surroundings of the cranes.

In a possible embodiment it is provided that the control units of the cranes form a network and exchange data with one another. For this purpose, the cranes preferably comprise corresponding transmission and receiving means which are connected to the control units. As a result, a wireless exchange of data between the cranes and further devices incorporated into the network. Alternatively, wired communications paths can also be incorporated into the network, e.g. when stationary cranes are used. At least one mobile display device is incorporated into the network and communicates with one or more cranes or their control units. Preferably, the mobile display device is associated with just one single crane. The data received from the crane can be displayed on the display device. The mobile working device can for example be configured as a tablet or as a mobile operating station.

In addition, each crane preferably has its own crane display, in particular in a driver's cab of the respective crane. All the relevant information regarding the actual crane can be displayable on the crane display, e.g. utilization, load and/or diagonal pull information. The mobile display device thus in particular forms a secondary display on which particular data of the associated crane or all other cranes involved with the multi-crane lifting can be displayed.

The mobile display device can simultaneously be or comprise an input means for specifying and/or controlling the load movement.

In a further possible embodiment it is provided that the mobile display device can be operated in a leading mode, in which information regarding all the cranes involved in the multi-crane lifting is displayed on the display device. The display device in the leading module is in particular operated by a supervisor or signaler who controls and/or monitors the multi-crane lifting and thus has to have sight of data relating to all the cranes involved. In leading mode, one or more of the following typical items of information can be displayable in any combination:
Information relating to the identity and/or a current setup condition of the cranes. This can include a serial number or other identification of the respective cranes.
Information relating to the current lifting heights of the trailing cranes compared with the current lifting height of the leading crane. This relation can be displayable as a difference and/or as a ratio. In addition, a graphical display of the respective permissible window may take place.
Information relating to a deviation of the lifting cable of at least one crane from the vertical. The display of the diagonal pull may take place graphically and/or numerically.
Information relating to a detected wind speed at at least one crane. Preferably the current wind speed is detected at each crane, via corresponding detection devices (e.g. anemometers).
Information relating to an activation of an emergency stop in a crane, for example on account of exceeding of a permissible threshold value for the load/lifting height/orientation of the lifting cable.
Information relating to loads currently acting on the cranes.
Information relating to an activated reduction of a maximally allowed load or permissible payload of a crane. This reduction can be active for one or more cranes, if e.g. not all the critical parameters for the monitoring of the diagonal pull or of the lifting height deviation are available.

In a further possible embodiment, it is provided that the mobile display device can be operated in an operator mode, in which only information relating to the associated crane (leading crane or trailing crane) is displayed on the display device. In operator mode, the display device is in particular operated by a crane driver of the leading crane or of a trailing crane. In the operator mode, one or more of the following typical items of information can be displayable in any combination:
Information relating to the identity and/or a current setup condition of the associated crane. This can include a serial number or other identification of the crane.
Information relating to the current lifting height of the crane. If the crane in question is the leading crane, only the lifting height may be displayable. If it is a trailing crane, alternatively or in addition to the current lifting height the current lifting height compared with the current lifting height of the leading crane can be displayable, for example as a difference and/or as a ratio. In addition, a graphical display of the permissible window may take place.
Information relating to a deviation of the lifting cable from the vertical. The display of the diagonal pull may take place graphically and/or numerically.
Information relating to a detected wind speed at the crane.
Information relating to an activation of an emergency stop, for example on account of exceeding of a permissible threshold value for the load/lifting height/orientation of the lifting cable.
Information relating to a load currently acting on the crane.
Information relating to an activated reduction of a maximally allowed load or permissible payload of a crane.

The mentioned information can be displayable graphically in leading mode and/or in operator mode, optionally supplemented by corresponding numerical information.

It can be provided that a plurality of display devices are incorporated into the network and that the crane of which the associated mobile display device is switched into leading mode is automatically defined as the leading crane (or vice versa: a specification of a crane as the leading crane automatically switches the associated display device into the leading mode, while the display devices of the remaining cranes are automatically operated in the operator mode).

In a further possible embodiment it is provided that at least two mobile display devices are present and incorporated into the crane network, wherein one of the display devices is associated with the leading crane and is operated in the leading mode, while the at least one other display device is associated with a trailing crane and is operated in the operator mode, wherein preferably each trailing crane is associated with a display device operated in the operator mode.

Preferably there is always just one leading crane or one mobile display device in leading mode in the network.

Preferably distinct names or aliases can be provided for each crane in the network, in order to be able to display these for example in leading mode on a mobile display device. This is more intuitive than e.g. abstract sequences of numbers.

Preferably, in leading mode, all the information of a crane is spatially summarized on the display. Preferably the spatial arrangement of each crane can be shifted as desired in the representation on the display device.

Preferably an individual corridor or an individual window for the lifting height deviation from the leading crane can be defined for each trailing crane.

The invention furthermore relates to a corresponding system for moving a load by means of a plurality of cranes. The system, which is preferably configured for carrying out the method according to the invention according to any of the variants described above, comprises a plurality of cranes for carrying out joint lifting of a load. The cranes each comprise, as has already been described above, an upper structure that is rotatable by means of a slewing gear about a vertical axis of rotation, a jib that can be luffed about a horizontal axis by means of a luffing mechanism, a load receiving means that is vertically adjustable by means of a lifting mechanism and is intended for receiving a load, and a control unit by means of which the upper structure, jib and load receiving means are automatically controllable. The control units are preferably configured to carry out the method according to the invention (i.e. the steps described above, which relate to the control units and can be performed thereon).

The system according to the invention is characterized in that one of the cranes can be defined as the leading crane, and the control units are configured to control the trailing cranes such that their movements follow the movements of the leading crane, wherein the control units of the cranes are configured for data exchange. The control units are preferably configured to automatically control the trailing cranes accordingly. A manual control can also take place, as described above with respect to the method according to the invention.

According to the invention, the control units are configured to control and/or to regulate the lifting mechanisms of the trailing cranes, upon lifting or lowering of the load, in such a way that the lifting heights remain within specified windows around the lifting height of the leading crane. The regulation for repositioning the lifting heights can be performed by the operator or crane driver. For this purpose, said operator or driver is provided with the information required for this (e.g. the own current lifting height, the current lifting height of the leading crane, the defined window, a limit of the window, and/or a parameter representing the current deviation from the leading crane lifting height—optionally with respect to a limit). This information can be displayable on a crane display and/or on a mobile display device associated with the trailing crane. In this case, the crane driver is assisted with the manual repositioning of the lifting height, such that the lifting heights of the trailing cranes can remain with in specified windows around the lifting height of the leading crane.

Alternatively, the regulation of the lifting height repositioning can be performable automatically by the control units of the trailing cranes, and the control units can be configured accordingly. For this purpose, the control units of the respective trailing cranes regulate the lifting mechanisms such that the contact points remain within the windows defined by the lower and upper limits.

According to the invention, the control units are furthermore configured to automatically control and/or regulate the luffing and lifting mechanisms of the crane, for a lateral movement of the load in the jib direction, such that the lifting height remains constant in the case of a luffing movement of the jib.

According to the invention, at least one crane comprises a measuring device for detecting a deviation from the vertical of a lifting cable carrying the load receiving means, wherein the control unit of said crane is configured to actuate and/or control the luffing mechanism and/or the slewing gear, in the case of an identified deviation, in such a way that the deviation is compensated or no inadmissible deviation occurs.

With regard to the properties, advantages and possible embodiments of the system according to the invention or the individual components of the system, the above statements regarding the method according to the invention, i.e. the resulting advantages, properties and the possible embodiments, apply analogously, and therefore a repeated description is omitted. The system cam comprise any of the components, properties or embodiments described with respect to the method according to the invention, in any combination.

In a possible embodiment it is provided that the control units of the cranes form a network and are configured to exchange data with one another, wherein the system comprises at least one mobile display device which is incorporated into the network and is configured to receive and display data from at least one crane. The above statements regarding possible embodiments of the network or of the mobile display device(s) apply analogously for the system according to the invention.

In a further possible embodiment it is provided that the system comprises an input means as described above and/or at least one monitoring means as described above.

The invention furthermore relates to a corresponding computer program product for carrying out the method according to the invention, which comprises commands which, when the program is executed, cause the steps of the above-described method (in any embodiment) relating to the control units to be carried out by the control units of the cranes. This of course does not refer to the steps which are carried out by human operators.

The computer program product can furthermore comprise commands which are carried out by one or more of the mobile display devices described above, and for example implement the above-described leading mode and/or operator module.

Preferably, the computer program product can be run on conventional crane controllers, such that no retrofitting of hardware components is necessary. In this case, conventional load torque limitations can be incorporated, as mentioned above.

### BRIEF DESCRIPTION OF THE FIGURES

Further features, details and advantages of the invention emerge from the following embodiments explained with reference to the figures, in which:

FIG. 1: is a schematic view of the system according to the invention according to an embodiment with a leading crane and two trailing cranes;

FIG. 2: shows two cranes when performing tandem lifting using the method according to the invention; and

FIG. 3: is an enlarged view of the jib tip of a crane of the system according to the invention comprising a measuring device for determining the verticality of the lifting cable, according to an embodiment.

### DETAILED DESCRIPTION

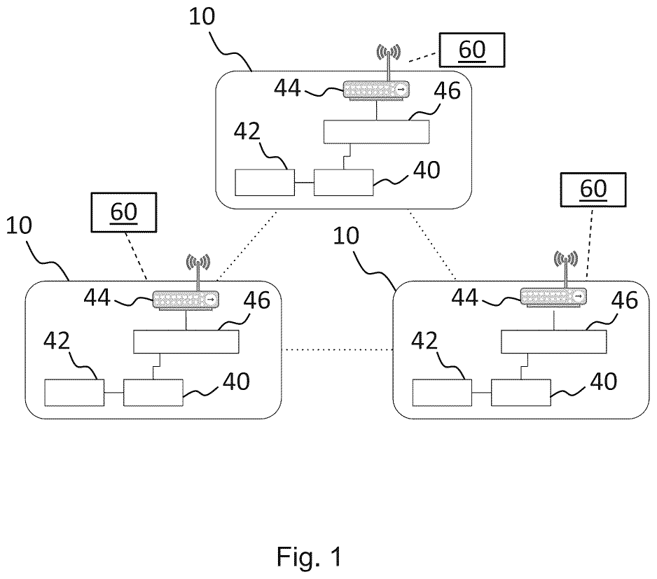

FIG. 1 shows an embodiment of the system according to the invention comprising three cranes 10 for carrying out the method according to the invention. The system comprises a leading crane and two trailing cranes. The cranes 10 each comprise a control unit 40, which may for example be a crane controller. Each crane 10 further comprises its own display unit 42, for example a crane display in a crane driver's cab. The cranes 10 are communicatively interconnected via transmission and receiving means 44, which in the embodiment shown here are connected to the control units 40 via coupling devices 46 (e.g. “manages switch” or NAT), and can exchange data wirelessly. The cranes 10 thus form a network. In this case, preferably each crane 10 is connected to every other carne 10 (or their control units 40).

Furthermore, each crane 10 is associated with a mobile display device 60 which is ideally always wirelessly connected just to one single crane 10. The mobile display devices 60 can be tablets or any other mobile devices (e.g. laptops, smartphones, mobile control devices, etc.). The mobile display devices 60 form secondary displays, on which certain information is displayed (see below for more on this).

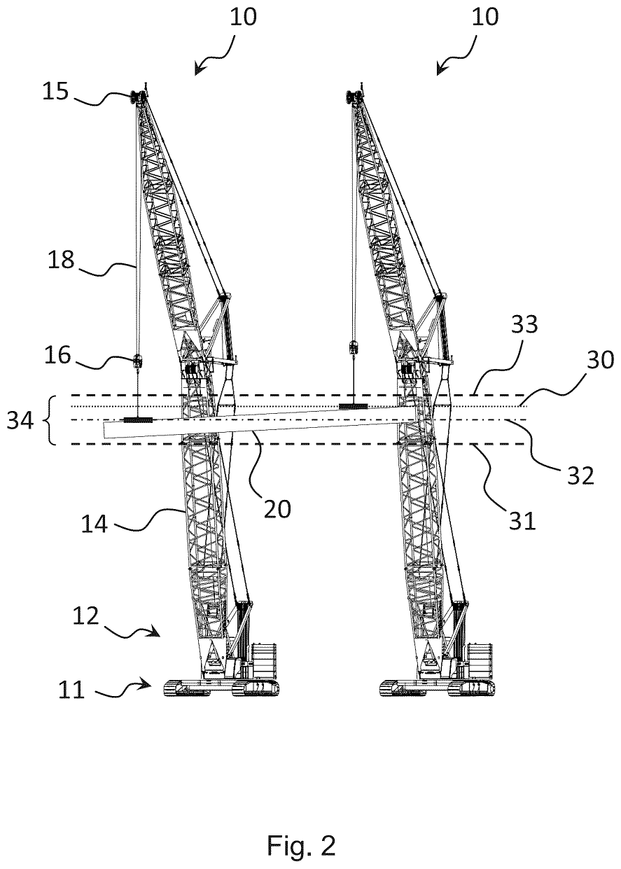

In the case of the embodiment described here, all the cranes 10 of the system that are involved in the multi-crane lifting are mobile cranes comprising a movable undercarriage 11 (e.g. with a crawler track, wherein cranes 10 without crawler tracks are also possible) and an upper structure 12 that is mounted on the undercarriage 11 so as to be rotatable about a vertical axis. In the present case, generally movable cranes are understood to be mobile cranes, inter alia also lattice mast cranes. An embodiment for a crane 10 which is involved in multi-crane lifting according to the invention is shown in FIG. 2—there using the example of tandem lifting with one leading crane (left-hand crane 10) and one trailing crane (right-hand crane 10). The cranes 10 comprise a jib 14 which can be luffed up and down about a horizontal axis and over the jib tip 15 of which a lifting cable 18 is guided, which cable is mounted on a lifting cable winch, which is preferably arranged on the upper structure 12, such that it can be wound up and unwound. In each case a load receiving means 16 is fastened to the lifting cable 18, to which the load 20 to be lifted can be fastened. The load 20 can comprise a crossbar which can be connected to the load receiving means 16 of the cranes 10.

In the embodiment shown in FIG. 2, the jibs 14 each comprise a main jib that is pivotably hinged to the upper structure 12, and a jib tip which is pivotably connected thereto and which can be braced and pivoted via bracing means. However, the exact equipping of the cranes 10 is not relevant for the method according to the invention. Likewise, other crane types or even stationary cranes (with luffing tip) could participate in the multi-crane lifting.

In the case of the cranes 10, the upper structure 12 can in each case be rotated by means of a slewing gear, the jib by can be luffed up and down by means of a luffing mechanism (e.g. a hydraulic luffing cylinder and/or guy cable winches), and the lifting cable 18 can be adjusted vertically by means of a lifting mechanism (in particular a drive for a lifting cable winch). In the case of the cranes 10 shown in FIG. 2, the luffing mechanism for example comprises deflection rollers mounted on a bracing support pivotably connected to the upper structure 12, adjustable guy cabling, and a further adjustable guy cabling between bracing supports arranged on the jib, for luffing the luffing tip relative to the main jib.

There is preferably a person responsible for the crane lifting (signaler/director of operations/supervisor) who coordinates the multi-crane lifting, and a crane driver for each crane 10. Alternatively, the lifting could also be performable automatically without intervention by crane drivers, with the result that there is only a signaler. A further possibility would be for one of the crane drivers (in particular the crane driver of the crane 10 defined as the leading crane) to simultaneously be the signaler.

Multi-crane lifting requires constant communication between the individual crane drivers and the signaler, in order to perform a synchronized movement of the involved cranes 10 and to prevent dangers. Furthermore, the center of gravity of the load 20 to be lifted must be known or calculated, as well as the mass of the load 20, the masses of the load receiving means 16, and the proportional cable weight and its distribution over the individual cranes 10. The diagonal pull of the lifting cables 18 and the utilization of the cranes or the current loads with respect to the respective permissible payloads must also be monitored, during the lifting process. There are risks in the case of multi-crane lifting for example due to overloading of a crane 10 on account of diagonal pull or on account of a shift in the center of gravity due to non-synchronous lifting/lowering of the load.

If it is not possible to precisely detect and correct all the relevant influencing and risk factors, e.g. ISO12480-1:1997—Cranes—Safe use—Part 1: General, under 11.4.4, requires an appropriate downgrading of the payload utilization (also referred to as reduction or limitation of the TLT utilization) for all the involved cranes to be carried out. The downgrading can be 25% or more. The nominally permissible utilization of the payload can thus be 75% or less. If, in contrast, all the mentioned influencing and risk factors can be precisely determined and monitored by instruments, then the cranes 10 can be used up to their nominal payload.

The method according to the invention allows for safe operation of the cranes 10 in multi-crane lifting taking into account all the relevant influencing and risk factors, such that the nominal loads of the cranes 10 involved can be utilized optimally. Furthermore, the safety of the multi-crane lifting is increased as intelligent control and synchronization of the cranes 10 takes place, without the need for complex alteration or retrofitting measures having in existing cranes for this purpose. This is made possible by the simultaneous use of a plurality of assistance systems on the individual cranes 10 and the implementation of a network for communication and synchronization of the cranes 10 involved.

Possible assistance systems are set out in the following on the basis of a preferred embodiment, which assistance systems are used simultaneously in each crane 10 involved in the multi-crane lifting. These assistance systems are executed by the respective control units 40.

### 1. “Horizontal Load Path” (HLP) Assistance System

Upon activation by the operator, the load 20 is automatically moved horizontally, i.e. at a constant height, upon luffing of the jib 14 of a crane 10. The load coordination in the case of a plurality of cranes 10 (but also in the case of the individual cranes 10) is simplified as a result. The load 20 remains at a constant height, although the luffing mechanism is actuated.

As a result, in the case of jib luffing from two individual movements (e.g. luffing down leads to an increase in the horizontal spacing of the load 20 from the upper structure 12 and simultaneously to a reduction in the height of the load 20) results in a single movement (change in the horizontal spacing of the load 20 from the upper structure 12). In the case of rotation (additional change in the upper structure angle of rotation), three individual movements result in two movements (angle of rotation and horizontal spacing of the load 20 from the upper structure 12).

### 2. “Vertical Line Finder” (VLF) Assistance System

If, in the case of multi-crane lifting, the spacings of the jib tips 15 are not identical to the spacings of the contact points of the load 20 on the load receiving means 16, diagonal pulls in the lifting cables 18 occur in the cranes 10, and potentially damaging additional stresses arise which can lead to overloading of the crane structures. In this case, the forces caused by the diagonal pull are always in equilibrium. If one crane 10 has a diagonal pull, at least one second crane 10 also has a diagonal pull.

In the diagonal pull monitoring system VLF, the diagonal pull of the lifting cable 18 towards the front/rear and to the side is displayed and optionally corrected. Thus, the operator or crane driver can identify and prevent lateral and front pull. In one or more cranes 10 of the system, the diagonal pull of the lifting cable 18 to the front/rear and to the side is measured by means of a sensor system 50. It is preferably displayed to the crane driver, on the crane display 42, whether the lifting cable 18 is in the vertical position (e.g. in the form of a plan view of the jib tip 15 and the load 20).

If there is diagonal pull, it can be provided that upon actuation by the crane driver (e.g. via an input button on the master switch) the crane 10 automatically corrects the diagonal pull by compensating movements in the luffing mechanism and in the slewing gear. Alternatively, a correction can be performable automatically (i.e. without intervention of the crane driver) by the control unit 40. A superimposed rotation or luffing by the crane driver is preferably possible at any time. If the crane driver actuates the slewing gear, correction is carried out by the luffing mechanism such that no diagonal pull occurs, and upon actuation of the luffing mechanism, correction is carried out via the slewing gear.

Monitoring and correction of the diagonal pull preferably also takes place when the crane 10 is moved via the chassis of the undercarriage 11, i.e. the crane 10 corrects the diagonal pull upon actuation by the crane driver or fully automatically by compensating movements in the slewing gear and luffing mechanism. When the cranes 10 move in multi-crane lifting with the chassis, it is often difficult for all the cranes 10 to undertake exactly the same direction of travel. Since the chassis actuation is in general not precise, drifting apart of the cranes 10 and thus diagonal pulls can occur on account of rolling resistances. The assistance system VLF displays the diagonal pull resulting from the mentioned drive, and corrects this correspondingly.

Due to the described force equilibrium, a compensation of the diagonal pull in one of the cranes 10 automatically leads to a compensation in the other cranes 10. Therefore, the assistance system VLF has to be active in at least one of the cranes 10. Preferably it is activated in each crane 10, wherein in a further embodiment the control units reconcile with each other the cranes 10 in which the diagonal pull is corrected by compensating movements in the luffing mechanism and slewing gear. This can also take place simultaneously in a plurality of cranes 10 in a coordinated manner, wherein a correction by a single crane 10 is easier to carry out and is generally sufficient.

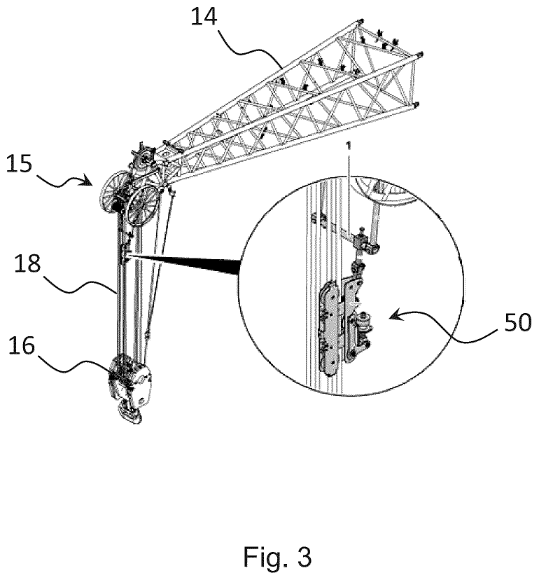

FIG. 3 shows an embodiment for a sensor system 50 for detecting the diagonal pull of the lifting cable 18. The jib tip 15 of a luffing tip 14 with a deflection roller is visible, via which the lifting cable 18 with the load receiving means 16 (here: bottom hook block) is guided. One of the reevings of the lifting cable 18 is connected to a measuring device 50 fastened to the jib tip 15, which measuring device detects the deviation of the lifting cable 18 from the vertical to the side (i.e. to the left/right) and in parallel with the luffing plane (i.e. forwards/backwards) and forwards this to the control unit 40. Alternative detection devices are of course conceivable.

### 3. “Load levelling” Assistance System

A synchronous lifting/lowering of the jointly lifted load 20 is a prerequisite for safe multi-crane lifting. The cranes 10 involved must remain at a relative hook height or lifting height (defined here as the height of the contact point of the load 20 on the load receiving means 16 of a crane 10), in order to keep the load 20 balanced. In the method according to the invention, one of the cranes 10 involved is declared the leading crane (“leader”), to which the remaining cranes 10 (trailing cranes or “follower”) are oriented.

The control units 40 of the cranes 10 measure, using the sensor system of the cranes 10, their lifting heights 30 or 34 and mutually exchange this information wirelessly via transmission and receiving means 44, such that the lifting heights 30 of the trailing cranes remain manually or automatically within a specified window 34 (“load level window”) around the contact point or the lifting height 32 of the leading crane. A fully automatic lifting height repositioning is preferred here, since this significantly facilitates the process. This process is illustrated in FIG. 2 on the basis of an embodiment, wherein the left-hand crane 10 is the leading crane. The lifting height thereof is indicated by the dot-dashed line 32. For the trailing crane (right-hand crane 10), a window 34 is defined, which is characterized by a maximum upper spacing from the lifting height 32 of the leading crane (upper dashed line 33) and a maximum lower spacing from the lifting height 32 of the leading crane (lower dashed line 31). The upper and lower spacings of the window 34 from the lifting height 32 of the leading crane can, as shown in FIG. 2, be selected identically or also differently in the individual trailing cranes. The contact point of the trailing cranes or their lifting height (characterized by the dotted line 30) must remain with its selected window 34. The lifting mechanism of the trailing crane is regulated manually or automatically by the control unit 40 in such a way that this is ensured.

In the case of a plurality of trailing cranes, this applies for each individual trailing crane. The windows 34 of the trailing cranes can be specified or specifiable identically or individually for each crane (e.g. corresponding to the center of gravity displacement permissible for the lifting, and the associated load change of each crane).

A synchronous lifting process by means of the method according to the invention using the “load levelling” assistance system can take place as follows: After the load contacts, each trailing crane sets its hook height, relative to the leading crane (i.e. the lifting height difference Δheight), to zero. During the lifting (and also during lowering) of the load 20, each trailing crane must keep the difference Δheight within a fixed window 34 around zero. If one trailing crane does not keep to the specified limits 31, 33, a visual or audible warning is sent to the mobile display device 60 and/or to all the cranes 10, and/or all the movements are stopped (i.e. automatic intervention of the control units 40 in the crane controllers). Subsequently, the lifting height 32 of one or more trailing cranes can be corrected manually or preferably automatically by the control units 40. After height correction has taken place, the crane movements can be released and continued.

An appropriate limitation of the TLT utilization in multi-crane lifting is preferably 10%, under the following prerequisites:

On the crane 10:
VLF assistance system for detecting and displaying the diagonal pull,
HLP assistance system for reducing the movement complexity,
Cable length measurement for implementing load levelling,
Network between the cranes involved (multiple crane lift network or “connectivity”)
Display units for displaying the relevant parameters.

On the display unit (crane display 42 and/or mobile display device 60—cf. FIG. 1): visualization of the parameters of all the cranes 10 involved in the lifting, in particular of the load levelling.

It is noted that, in accordance with ISO 12480-1, when using the above assistance systems all the relevant factors are precisely detected and corrected, and thus no downgrading of the TLT utilization would be necessary. However, nonetheless, for safety reasons, a corresponding reduction in the TLT utilization may be advisable.

The individual cranes 10 (leading crane and trailing cranes) preferably additionally have load torque limitation (LTL), in order to monitor exceeding of the own maximally allowable payload during multi-crane lifting, and optionally intervene promptly. The above-described limitation of the TLT utilization in particular does not take place in the form of a payload reduction in the LTL, but rather only as an indication/warning to the crane driver that the planned nominal load (planned nominal load under jib head in multi-crane lifting) may not be higher than a specified value (e.g. 90% of the allowable payload) at this radius. The person responsible for the lifting or the signaler can preferably specify further limitations, in particular for each crane 10 involved, which do not transmit any information (diagonal pull, loading, etc.). If there is no detection and no correction possibilities on the crane 10, at least the 25% reduction according to ISO 12480-1 is to be applied.

In addition, it is preferably possible for the crane driver to activate the limitation of the TLT utilization as well as the active TLT reduction (with correspondingly reduced stops and pre-warnings), as is described in the following with reference to an embodiment:

By the “reduction of the permissible payload utilization”, the switching off (stopping of the movements) and the pre-warning (displaying on the screen or crane display 42) of the payload utilization can be reduced manually by the user, individually in certain steps (e.g. 1% steps). The reduction is maintained when the crane controller is switched off and on again.

The maximally permissible payload represents the limit of each crane 10 and the switching off associated therewith is preferably performed as a safety function (overload protection LTL), which the operator cannot influence or change. The safety function is in particular also still active when reduction of the permissible payload utilization is selected.

In a preferred embodiment, the operator can reduce the permissible payload utilization at his own discretion, for operation. This operational reduction is lower than the limit of the crane 10 and therefore represents an operational restriction and not a limitation of the limit of the crane 10.

The overload protection (LTL) can for example have implemented the following limit values: Limit value LTL switch-off: 100%, limit value LTL pre-warning: 90%. Other limit values and/or a plurality of pre-warning stages are of course conceivable. The “reduction of the permissible payload utilization” in particular uses the same functionality (also with respect to dead-lock/set-up button) as the LTL.

The reduction in the permissible payload utilization can preferably be set by the operator. The adjustment range can be between 20% and 100%. The reduction of the pre-warning can preferably be set separately by the operator. The adjustment range can be between 18% and 90%, wherein the spacing between switch-off and pre-warning can be at least 1/10 of the selected switch-off value.

At this point it should be emphasized that all the mentioned ratio and numerical values are merely by way of example and may differ from the mentioned values for all the cranes 10 or for certain cranes 10 of the system according to the invention.

With reference to the embodiment shown in FIG. 1, in the following the network of the cranes 10 of the system according to the invention that are involved in the multi-crane lifting will be described again:

In order that the crane driver and the person responsible for the crane lifting or the signaler can communicate digitally and/or exchange information with one another without the cranes 10 having to be wired together, a wireless connection/communication between the cranes 10 involved in the lifting and the signaler is required The information called up from the cranes 10 for safe multi-crane lifting is displayed either on the crane display 42 or on secondary displays of the mobile display devices 60 (e.g. tablets), wherein the secondary display can be connected into the network for example via an ethernet or via a WLAN access point. The signaler has his own display or uses the crane display 42 of the leading crane.

The cranes 10 are thus communicatively interconnected via wireless connections. In the case of WLAN-based communication, preferably a proprietary Phoenix Contact mesh grid is used in order to limit the communication to the cranes 10 of the system. Although each mobile device can see the network, no third-party device can log into said mesh grid Since the local machine networks are preferably virtually identical on all the cranes 10 (possibly with the exception of some add-ons), preferably NAT (network address translation) technology is used.

The mobile display devices 60 can for example be incorporated into the network via ethernet or WLAN and can communicate with the associated cranes 10. When WLAN is used, the mobile display device 60 would not be considered a mesh node but rather an individual device which is connected to exactly one access point (i.e. to exactly one crane 10).

The information called up from the other cranes 10 should ideally not be displayed on the actual crane display 42 but rather on the mobile display devices 60 (secondary displays). For this purpose, preferably a software runs on the latter which calls up the required information from the current crane 10 and from the other cranes 10 in the same network. The crane display 42 should display all the relevant information relating to the actual crane 10 (e.g. utilization, load and/or diagonal pull information).

For the communication with the Master-5, inter alia two approaches can be used: MCOM or rtp-web_service. The number of devices which communicate with one control unit 40 must be reduced to a minimum in order to keep the loading of the control unit 40 low. Too many devices calling up information from the control unit 40 can impair the operation.

Preferably, the mobile display devices 60 can be operated in two modes: leading mode (view for the signaler or supervisor) and operator mode (view for the crane driver(s)). It is preferably possible to select between these visualizations.

There is preferably just one mobile display device 60 in leading mode (=leading device) in the entire network. All the other devices are operated in operator mode. The first mobile display device 60, which is declared the leading device, is switched to leading mode. The associated crane 10 is preferably automatically determined as the leading crane. The other cranes 10 become trailing cranes.

### Leading Mode

One or more of the following items of information of each crane 10 involved in the multi-crane lifting is shown on a common view or display:
a) serial number (identification),
b) TLT utilization,
c) set reduction of the permissible TLT utilization,
d) lifting height difference from the leading crane, including allowable corridor (window 34),
e) diagonal pull to the side (left/right) and in parallel with the luffing plane (forwards/backwards),
f) movement stop activated (e.g. after exceeding of the maximally permissible payload of a crane 10),
g) emergency stop activated,
h) maximum wind speed over all cranes 10 involved.

The maximum value of b), c) and d) is preferably visually highlighted for faster or improved overview. All the information of a crane 10 is preferably spatially summarized in leading mode, wherein the spatial arrangement of each crane 10 in the mobile display device 60 (leading device) in the illustration can be displaceable as desired. Each serial number can preferably be supplemented by an alias name.

### Operator Mode

Display of at least one of the following items of information regarding the associated crane 10:
a) lifting height difference from the leading crane, including specified window 34 of the own crane 10,
b) emergency stop activated in a crane 10,
c) TLT utilization on the own crane 10,
d) set reduction of the permissible TLT utilization (switch-off) on the own crane 10,
e) diagonal pull to the side (left/right) and in parallel with the luffing plane (forwards/backwards) on the own crane 10,
f) wind speed on the own crane 10.

### LIST OF REFERENCE SIGNS

10 crane
11 undercarriage
12 upper structure
14 jib
15 jib tip
16 load receiving means
18 lifting cable
20 load
30 trailing crane lifting height
31 lower limit of the window for the lifting height
32 leading crane lifting height
33 upper limit of the window for the lifting height
34 window for lifting height
40 control unit
44 transmission and receiving means
46 coupling device
50 lifting cable measuring device
60 mobile display device

1. Method for moving a load using a plurality of cranes, wherein the cranes each comprise an upper structure that is rotatable by means of a slewing gear about a vertical axis of rotation, a jib that can be luffed about a horizontal axis by means of a luffing mechanism, a load receiving means that is vertically adjustable by means of a lifting mechanism and is intended for receiving a load, and a control unit by means of which the upper structure, jib and load receiving means are automatically controllable,
wherein
one of the cranes is defined as a leading crane, the movements of which are followed by the other cranes (trailing cranes), wherein the control units of the cranes exchange data for this purpose,
upon lifting or lowering of the load, the lifting mechanisms of the trailing cranes are regulated, such that the heights of the contact points of the load on the respective load receiving means of the trailing cranes (lifting heights) remain within a defined window around the lifting height of the leading crane,
the luffing and lifting mechanisms of the cranes are automatically controlled and/or regulated for a lateral movement of the load such that during a luffing movement of a jib the lifting height remains constant, and
a deviation of the lifting cable from the vertical is measured for at least one crane, and if a deviation is detected, the luffing mechanism and/or slewing gear is controlled and/or regulated by the control unit such that the deviation is compensated for.

2. Method according to claim 1, comprising at least three cranes, wherein different windows for the lifting height are specified and/or can be specified for at least two trailing cranes.

3. Method according to either claim 1, wherein after contact of the load the lifting heights of the trailing cranes relative to the lifting height of the leading crane are set to a fixed value.

4. Method according to claim 1, wherein the load receiving means of the cranes are suspended on lifting cables which are guided over the jib tips of the jibs, wherein the movements of the trailing cranes are automatically matched to the movement of the leading crane in such a way that the lateral spacings of the jib tips from one another remain constant and/or that a specified orientation of the lifted load remains constant.

5. Method according to claim 1, wherein a warning is output and/or the movements of all the cranes are stopped if the lifting height of a trailing crane is outside its specified window or if the detected deviation of a lifting cable from the vertical exceeds a specified threshold value.

6. Method according to claim 1, wherein the movement of the lifted load is specified and/or controlled via input means, wherein the leading crane is controlled on the basis of the control commands input via the input means and the trailing cranes follow the leading crane in such a way that the load performs the specified movement.

7. Method according to claim 1, wherein each crane comprises a monitoring means for load torque limitation, which monitoring means receives a load currently acting on the respective crane and detected via a detection device, and compares this with a maximally permitted load, wherein a warning is output and/or the movements of all the cranes are stopped when a load currently acting on one of the cranes exceeds the maximally permitted load.

8. Method according to claim 1, wherein the control units of the cranes form a network and exchange data with one another, wherein at least one mobile display device is integrated in the network and receives and displays data from at least one crane, wherein the mobile display device is preferably associated with just one crane.

9. Method according to claim 8, wherein in a leading mode information regarding all the cranes is displayed on the mobile display device, including one or more of the following items of information relating to:
the identity and/or a current setup condition of the cranes,
the current lifting heights of the trailing cranes compared with the current lifting height of the leading crane,
a deviation of the lifting cable of at least one crane from the vertical,
a detected wind speed at at least one crane,
an activation of an emergency stop for one crane,
loads currently acting on the crane,
an activated reduction of a maximally permitted load of a crane.

10. Method according to claim 9, wherein in an operator mode information regarding an associated crane is displayed on the mobile display device, including one or more of the following items of information relating to:
the identity and/or a current setup condition of the cranes,
a current lifting height compared with the current lifting height of the leading crane,
a deviation of the lifting cable from the vertical,
a detected wind speed at the crane,
an activation of an emergency stop,
a load currently acting on the crane,
an activated reduction of a maximally permitted load of the crane.

11. Method according to claim 10, wherein at least two mobile display devices are present, wherein one of the mobile display devices is associated with the leading crane and is operated in leading mode, and the at least one other mobile display device is associated with a trailing crane and is operated in the operator mode, wherein each trailing crane is associated with a mobile display device operated in the operator mode.

12. System for moving a load by means of a plurality of cranes, comprising at least two cranes, which each comprise an upper structure that is rotatable by means of a slewing gear about a vertical axis of rotation, a jib that can be luffed about a horizontal axis by means of a luffing mechanism, a load receiving means that is vertically adjustable by means of a lifting mechanism and is intended for receiving a load, and a control unit by means of which the upper structure, jib and load receiving means are automatically controllable,
wherein
one of the cranes can be defined as a leading crane and the control units are configured to automatically control the cranes not defined as the leading crane (trailing cranes) in such a way that their movements follow the movements of the leading crane, wherein the control units of the cranes are configured to exchange data,
the control units are configured, upon lifting or lowering of the load, to control and/or to regulate the lifting mechanisms of the trailing cranes such that the heights of the contact points of the load on the respective load receiving means (lifting heights) remain within a defined window around the lifting height of the leading crane,
the control units are configured to automatically control and/or regulate the luffing and lifting mechanisms of the cranes for a lateral movement of the load such that during a luffing movement of the jib the lifting height remains constant, and
at least one crane comprises a measuring device (50) for detecting a deviation of the lifting cable, carrying the load receiving means, from the vertical, wherein the control unit of said crane is configured, if a deviation is detected, to control and/or regulate the luffing mechanism and/or the slewing gear such that the deviation is compensated for.

13. System according claim 12, wherein the control units of the cranes form a network and are configured to exchange data with one another, wherein the system comprises at least one mobile display device which is integrated in the network and is configured to receive and display data from at least one crane.

14. System according to claim 13, further comprising at least one input means and/or at least one monitoring means.

15. Computer program product comprising commands which, when the program is executed, cause the steps of the method according to claim 1 relating to the control units to be carried out by the control units of the cranes.
